(19) United States
(12) Patent Application Publication
(10) Pub. No.: US 2026/0002047 A1
(43) Pub. Date: Jan. 1, 2026

(54) LOW-DIELECTRIC BLACK POLYIMIDE FILM AND PREPARATION METHOD THEREOF

(71) Applicant: PI ADVANCED MATERIALS CO., LTD., Chungcheongbuk-do (KR)

(72) Inventors: Moon-Jin YEO, Daejeon (KR); Kil-Nam LEE, Gyeonggi-do (KR)

(21) Appl. No.: 18/703,465

(22) PCT Filed: Oct. 24, 2022
(86) PCT No.: PCT/KR2022/016273

§ 371 Date: Jun. 13, 2025

(30) Foreign Application Priority Data
Oct. 25, 2021 (KR) 10-2021-0142449

(51) Int. Cl. C09D 179/08

(52) U.S. Cl. CPC C09D 179/08

(57) ABSTRACT

The present invention relates to a polyimide film having transmittance of 1.0% or lower, glossiness of 50% or lower, and a dielectric loss rate of 0.01 or lower, and a preparation method thereof. The polyimide film having adjusted the type and composition ratio of dianhydride component, diamine component and carbon black has the advantage of exhibiting excellent optical properties, dielectric properties and chemical resistance.

### TECHNICAL FIELD

The present disclosure relates to a polyimide film having excellent optical, dielectric, and chemical-resistant properties and to a formation method thereof.

### BACKGROUND ART

Polyimide (PI) is a polymeric material having the highest level of heat resistance, chemical compatibility, electrical insulation, chemical resistance, and weather resistance of all organic materials on the basis of an imide ring having excellent chemical stability along with a rigid aromatic main chain.

Polyimide films are attracting attention as a material for various electronic devices in need of the properties mentioned above.

In particular, polyimide films have recently been used widely as coverlays in portable electronic devices and communication devices. Coverlays, used to protect electronic components such as printed wiring boards, lead frames of semiconductor integrated circuits, and the like, require physical properties such as thinning and slimming. Additionally, security, portability, visual effects, and concealing properties of electronic components and mounting components, as well as optical properties, have also been recently required.

Carbon black and the like are mixed with a polyimide film to meet such optical properties.

However, existing polyimide films containing carbon black have poor dielectric properties to be used for high-speed transmission, making the application thereof to 5G electronic devices challenging.

Therefore, there is an urgent need to develop polyimide films with both excellent optical and dielectric properties.

### DOCUMENT OF RELATED ART

### Patent Document

(Patent Document 1) Korean Patent No. 10-1045823

### DISCLOSURE

### Technical Problem

Accordingly, the present disclosure aims to provide a polyimide film having excellent optical, dielectric, and chemical-resistant properties.

However, the problems to be solved by the present disclosure are not limited to the above description, and other problems can be clearly understood by those skilled in the art from the following description.

### Technical Solution

In one aspect of the present disclosure for achieving the object as described above, a polyimide film having a transmittance of 1.0% or lower, a glossiness of 50% or lower, and a dielectric loss factor of 0.01 or lower
is provided.

In another aspect of the present disclosure, a method of forming a polyimide film, which includes (a) preparing a polyamic acid by polymerizing an acid dianhydride component including two or more selected from the group consisting of biphenyl-tetracarboxylic dianhydride (BPDA), pyromellitic dianhydride (PMDA), oxydiphthalic anhydride (ODPA), and benzophenone tetracarboxylic dianhydride (BTDA) and a diamine component including two or more selected from the group consisting of para-phenylenediamine (PPD), m-tolidine, oxydianiline (ODA), and 1,3-bis(aminophenoxy)benzene (TPE-R) in an organic solvent,
(b) mixing and dispersing carbon black in the polyamic acid; and
(c) imidizing the polyamic acid,
wherein the carbon black includes one or more selected from the group consisting of bone black, lamp black, and thermal black,
is provided.

In a further aspect of the present disclosure, a coverlay including a polyimide film
is provided.

### Advantageous Effects

The present disclosure provides a polyimide film in which the composition ratios and types of acid dianhydride component, diamine component, and carbon black are adjusted, thereby providing a polyimide film having excellent optical, dielectric, and chemical-resistant properties.

Such a polyimide film can be applied to various fields in need of a polyimide film having excellent optical, dielectric, and chemical-resistant properties and can be, for example, applied to a coverlay.

### BEST MODE

All terms including technical and scientific terms used herein have the same meaning as commonly understood by those skilled in the art to which the present disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Therefore, the embodiments described herein are merely examples and do not exhaustively present the technical spirit of the present disclosure. Accordingly, it should be appreciated that there may be various equivalents and modifications that can replace the embodiments and the configurations at the time at which the present application is filed.

As used herein, the singular forms are intended to include the plural forms as well, unless the context clearly indicates otherwise. It will be further understood that the terms “comprise”, “include”, “have”, and the like when used herein, specify the presence of stated features, integers, steps, components, or combinations thereof but do not preclude the presence or addition of one or more other features, integers, steps, components, or combinations thereof.

As used herein, although the term “acid dianhydride” is intended to include precursors or derivatives thereof, these compounds may not technically be acid dianhydride. Nevertheless, these compounds will react with diamine to form polyamic acids, which will be converted to polyimides once more.

As used herein, although the term “diamine” is intended to include precursors or derivatives thereof, these compounds may not technically be diamines. Nevertheless, these compounds will react with dianhydride to form polyamic acids, which will be converted to polyimides once more.

When an amount, concentration, other value, or parameter is given herein as a range, preferred range, or enumeration of preferred upper values and preferred lower values, it is to be understood to specifically disclose all ranges formed by a pair of any upper range limit or a preferred value and any lower range limit or a preferred value, regardless of whether the ranges are additionally disclosed.

When a range of numerical values is mentioned herein, this range is intended to include not only the endpoints but also all integers and fractions within the range, unless otherwise stated. The scope of the present disclosure is not intended to be limited to the specific values mentioned when defining the scope.

A polyimide film, according to one embodiment of the present disclosure, may have a transmittance of 1.0% or lower, a glossiness of 50% or lower, and a dielectric loss factor of 0.01 or lower.

Additionally, the polyimide film may have a dielectric constant of 4.0 or lower and a chemical resistance index of 90% or higher.

In one embodiment, the polyimide film may be obtainable by reacting a polyamic acid solution through an imidization reaction, the polyamic acid solution containing an acid dianhydride component including two or more selected from the group consisting of biphenyl-tetracarboxylic dianhydride (BPDA), pyromellitic dianhydride (PMDA), oxydiphthalic anhydride (ODPA), and benzophenone tetracarboxylic dianhydride (BTDA) and a diamine component including two or more selected from the group consisting of para-phenylenediamine (PPD), m-tolidine, oxydianiline (ODA), and 1,3-bis(aminophenoxy)benzene (TPE-R).

In particular, the polyimide film may be obtainable by reacting the polyamic acid solution through the imidization reaction, the polyamic acid solution containing the acid dianhydride component including two or more selected from the group consisting of biphenyl-tetracarboxylic dianhydride, pyromellitic dianhydride, and benzophenone tetracarboxylic dianhydride, and the diamine component including two or more selected from the group consisting of para-phenylenediamine, m-tolidine, and oxydianiline.

On the other hand, the biphenyl-tetracarboxylic dianhydride may have a content of 20 mol % or more and 50 mol % or less, the pyromellitic dianhydride may have a content of 25 mol % or more and 70 mol % or less, and the benzophenone tetracarboxylic dianhydride may have a content of 50 mol % or less, based on 100 mol % of the total content of the acid dianhydride component.

Additionally, the para-phenylenediamine may have a content of 5 mol % or more and 75 mol % or less, the m-tolidine may have a content of 25 mol % or more and 80 mol % or less, and the oxydianiline may have a content of 25 mol % or less, based on 100 mol % of the total content of the diamine component.

In the present disclosure, with the increasing content of para-phenylenediamine, a rigid monomer, the polyimide synthesized has a further linear structure and contributes to the improvement of the mechanical properties of the polyimide.

Additionally, m-tolidine has a particularly hydrophobic methyl group and thus contributes to the low hygroscopicity related to the dimensional stability of the polyimide film with respect to moisture.

In the present disclosure, the polyimide chain derived from biphenyl-tetracarboxylic dianhydride has a structure called a charge transfer complex (CTC), that is, a regular linear structure in which an electron donor and an electron acceptor are positioned close to each other, and the intermolecular interaction is strengthened.

Such a structure is effective in preventing hydrogen bonding with moisture and thus has an impact on reducing the moisture absorption rate, thereby maximizing the effect of reducing the hygroscopicity of the polyimide film.

In particular, the acid dianhydride component may additionally contain pyromellitic dianhydride. Pyromellitic dianhydride, the acid dianhydride component having a relatively rigid structure, is preferable in terms of providing appropriate elasticity to the polyimide film.

In order for the polyimide film to satisfy both appropriate elasticity and moisture absorption rate, the content ratio of acid dianhydride is particularly important. For example, as the content ratio of biphenyl-tetracarboxylic dianhydride decreases, a low moisture absorption rate based on the CTC structure is hard to expect.

Additionally, while biphenyl-tetracarboxylic dianhydride, oxydiphthalic anhydride, and benzophenone tetracarboxylic dianhydride contain two benzene rings corresponding to the aromatic moiety, pyromellitic dianhydride contains one benzene ring corresponding to the aromatic moiety.

The increase in the content of pyromellitic dianhydride in the acid dianhydride component may be understood as an increase in the imide group within the molecule based on the same molecular weight, indicating that the ratio of the imide group derived from pyromellitic dianhydride in the polyimide polymer chain increases relatively compared to that of the imide group derived from biphenyl-tetracarboxylic dianhydride.

In other words, an increase in the content of pyromellitic dianhydride may be seen as a relative increase in the imide group in the entire polyimide film, making it difficult to expect a low moisture absorption rate.

On the contrary, when the content ratio of pyromellitic dianhydride decreases, this means that the component having a relatively rigid structure is reduced, so the mechanical properties of the polyimide film may deteriorate below the desired level.

For this reason, when the content of biphenyl-tetracarboxylic dianhydride exceeds the above range, the mechanical properties of the polyimide film deteriorate, and an appropriate level of heat resistance required to manufacture a flexible metal-clad laminate may not be obtainable.

On the contrary, when the content of biphenyl-tetracarboxylic dianhydride is lower than the above range, or the content of pyromellitic dianhydride exceeds the above range, appropriate levels of the dielectric constant, dielectric loss factor, and moisture absorption rate may be challenging to achieve, which is undesirable.

As mentioned above, m-tolidine has a particularly hydrophobic methyl group and thus contributes to the low hygroscopicity of the polyimide film. Additionally, the low hygroscopicity resulting from m-tolidine contributes to the low dielectric loss factor of the polyimide film.

In one embodiment, the polyimide film contains carbon black, and the carbon black may include one or more selected from the group consisting of bone black, lamp black, and thermal black.

Typically, bone black is prepared by carbonizing animal bones and has a warm black color. Lamp black is prepared by collecting soot produced when burning mineral oils, such as petroleum or tar, has a blue color, and thus is used as a special printing ink for printing banknotes and the like. Thermal black is produced by thermal decomposition of natural gas and acetylene.

On the other hand, the polyimide film may not contain furnace black.

In one embodiment, the polyimide film may contain only bone black, a combination of bone black and lamp black, or a combination of bone black and thermal black.

Additionally, when the polyimide film contains bone black in combination with lamp black or thermal black, the weight ratio of bone black to lamp black or thermal black (wt % of bone black: wt % of lamp black or thermal black) may be in a range of 4:1 to 1.5:1.

In one embodiment, the carbon black may be contained in an amount of 1 wt % or more and 15 wt % or less based on 100 wt % of the polyimide film.

In one embodiment, the polyimide film may have a thickness of 7.5 μm or larger and 75 μm or smaller.

The preparation of a polyamic acid in the present disclosure may, for example, involve:
(1) a polymerization method by adding the entire amount of the diamine component in a solvent and then adding the acid dianhydride component so that the amount thereof is substantially equimolar to that of the diamine component;
(2) a polymerization method by adding the entire amount of the acid dianhydride component in a solvent and then adding the diamine component so that the amount thereof is substantially equimolar to that of the acid dianhydride component;
(3) a polymerization method by adding some of the diamine component to a solvent, mixing some of the acid dianhydride component in a ratio of about 95 to 105 mol % to the reaction component, adding the remaining diamine component, and then subsequently adding the remaining acid dianhydride component so that the diamine component and the acid dianhydride component are substantially equimolar;
(4) a polymerization method by adding some of the acid dianhydride component to a solvent, mixing some of the diamine compound in a ratio of about 95 to 105 mol % to the reaction component, adding the remaining acid dianhydride component, and then subsequently adding the remaining diamine component so that the diamine component and the acid dianhydride component are substantially equimolar;
(5) a polymerization method by reacting some of the diamine component and some of the acid dianhydride component in a first solvent so that either one is in excess to form a first composition, reacting some of the diamine component and some of the acid dianhydride component in a second solvent so that either one is in excess to form a second composition, and mixing the first and second compositions to complete polymerization, wherein when the diamine component is in excess when forming the first composition, the acid dianhydride component in the second composition is contained in an excessive amount, and when the acid dianhydride component is in excess in the first composition, the diamine component in the second composition is contained in an excessive amount to mix the first and second compositions so that the entire diamine component and acid dianhydride component used in the reaction are substantially equimolar; and the like.

In one specific example, a formation method of the polyimide film, according to the present disclosure, may include:
(a) preparing a polyamic acid by polymerizing an acid dianhydride component including two or more selected from the group consisting of biphenyl-tetracarboxylic dianhydride (BPDA), pyromellitic dianhydride (PMDA), oxydiphthalic anhydride (ODPA), and benzophenone tetracarboxylic dianhydride (BTDA) and a diamine component including two or more selected from the group consisting of para-phenylenediamine (PPD), m-tolidine, oxydianiline (ODA), and 1,3-bis(aminophenoxy)benzene (TPE-R) in an organic solvent;
(b) mixing and dispersing carbon black in the polyamic acid; and
(c) imidizing the polyamic acid.

In the present disclosure, such a polymerization method of the polyamic acid described above may be defined as a random polymerization method. Additionally, the polyimide film of the present disclosure, formed from the polyamic acid prepared through such a process described above, is preferably applicable in terms of maximizing the effect of the present disclosure for increasing dimensional stability.

However, the polymerization method makes the length of the repeating unit in the polymer chain described above relatively short, so there may be limitations in demonstrating each of the excellent properties of the polyimide chain derived from the acid dianhydride component. Therefore, block polymerization may be performed as the polymerization method of the polyamic acid, which is further preferably usable in the present disclosure.

On the other hand, the solvent for synthesizing the polyamic acid is not particularly limited, and any solvent capable of dissolving the polyamic acid may be usable. However, an amide-based solvent is preferably used.

Specifically, the organic solvent may be a polar organic solvent, which may be, in particular, a polar aprotic solvent. Examples thereof may include one or more selected from the group consisting of N,N-dimethylformamide (DMF), N,N-dimethylacetamide, N-methyl-pyrrolidone (NMP), gamma-butyrolactone (GBL), and diglyme, but the organic solvent is not limited thereto. If necessary, the organic solvent may be used alone, or two or more types may be used in combination.

In one example, N,N-dimethylformamide and N,N-dimethylacetamide are further preferably used as the organic solvent.

Additionally, in the polyamic acid preparation process, fillers may be added to improve various properties of the film, such as sliding properties, thermal conductivity, corona resistance, loop hardness, and the like. The filler added is not particularly limited, but preferred examples thereof include silica, titanium oxide, alumina, silicon nitride, boron nitride, calcium hydrogen phosphate, calcium phosphate, mica, and the like.

The particle diameter of the filler is not particularly limited but may be determined depending on the properties of a film to be modified and the type of fillers to be added. Typically, the average particle diameter is in a range of 0.05 to 100 μm, which is preferably in the range of 0.1 to 75 μm, more preferably in the range of 0.1 to 50 μm, and even more preferably in the range of 0.1 to 25 μm.

When the particle diameter is smaller than the above range, the modification effect may be challenging to exhibit. On the contrary, when the particle diameter exceeds the above range, the surface properties may be greatly damaged, or the mechanical properties may significantly deteriorate.

Additionally, the amount of the filler added is not particularly limited but may be determined by the properties of a film to be modified, the particle diameter of the filler, or the like. Typically, the amount of the filler added is in a range of 0.01 to 100 parts by weight, which is preferably in the range of 0.01 to 90 parts by weight and more preferably in the range of 0.02 to 80 parts by weight, based on 100 parts by weight of the polyimide.

When the amount of the filler added is smaller than the above range, the modification effect may be challenging to exhibit due to the filler. On the contrary, when the amount of the filler added exceeds the above range, the mechanical properties of the film may be significantly damaged. The method of adding the filler is not particularly limited, and any known methods may be used.

In the formation method of the present disclosure, the polyimide film may be formed by a thermal imidization method and a chemical imidization method.

Additionally, the polyimide film may be formed by a complex imidization method in combination of the thermal imidization and the chemical imidization methods.

The thermal imidization method is a method of inducing an imidization reaction using a heat source such as an infrared dryer or hot air, without involving a chemical catalyst.

The thermal imidization method may enable the amic acid group present in a gel film to be imidized by subjecting the gel film to heat treatment at a variable temperature in a range of 100° C. to 600° C. Specifically, the heat treatment may be performed at a temperature in a range of 200° C. to 500° C., which is more specifically in the range of 300° C. to 500° C., to imidize the amic acid group present in the gel film.

However, even in the gel film formation process, some of the amic acid (about 0.1 mol % to 10 mol %) may be imidized. To this end, the polyamic acid composition may be dried at a variable temperature in a range of 50° C. to 200° C., which may also fall within the scope of the thermal imidization method.

In the case of the chemical imidization method, a dehydrating agent and an imidizing agent may be used according to methods known in the art to form the polyimide film.

As one example of the complex imidization method, a dehydrating agent and an imidizing agent may be introduced into a polyamic acid solution, heated at a temperature in a range of 80° C. to 200° C., which is preferably in the range of 100° C. to 180° C., partially cured and dried, and then heated at a temperature in a range of 200° C. to 400° C. for 5 to 400 seconds, thereby forming the polyimide film.

The present disclosure provides a coverlay including the polyimide film described above.

### MODE FOR INVENTION

Hereinafter, the action and effect of the present disclosure will be described in detail through specific examples and preparation examples of the disclosure. However, these examples and preparation examples are provided only for illustrative purposes, and the scope of the present disclosure is not limited to the following embodiments.

### Preparation Example: Polyimide Film Formation

A polyimide film of the present disclosure may be formed by typical methods known in the art, as follows. First, the acid dianhydride and diamine components mentioned above are allowed to react in an organic solvent to obtain a polyamic acid solution.

In this case, the solvent used, typically an amide-based solvent, is a polar aprotic solvent, which may be N,N′-dimethylformamide, N,N′-dimethylacetamide, N-methyl-pyrrolidone, or a combination thereof.

The acid dianhydride and diamine components are enabled to be introduced in a solution, powder, or lump form. Preferably, the reaction occurs by introducing the acid dianhydride and diamine components in a powder form at the beginning of the reaction and then in a solution form to control the polymerization viscosity.

The polyamic acid solution obtained in such a manner may be mixed with carbon black, an imidization catalyst, and a dehydrating agent so as to be applied onto a support.

Examples of the catalyst used include tertiary amines (for example, isoquinoline, β-picoline, pyridine, and the like), and examples of the dehydrating agent include anhydrous acids, but the catalyst and the dehydrating agent are not limited thereto. Additionally, the support used above may be a glass plate, aluminum foil, circular stainless steel belt, stainless drum, or the like, but is not limited thereto.

The film applied onto the support is turned into a gel form on the support by drying air and heat treatment.

The gel film formed in such a manner is separated from the support, subjected to heat treatment for drying, and then imidized.

The film obtained through the heat treatment above may be subjected to heat treatment under a predetermined tension to remove residual stress generated in the film during the film formation process.

Specifically, 500 ml of dimethylformamide (DMF) is introduced while injecting nitrogen into a reactor equipped with a stirrer and nitrogen injection/discharge pipes, and the reactor temperature is set to 30° C. Next, biphenyl-tetracarboxylic dianhydride (BPDA), pyromellitic dianhydride (PMDA), benzophenone tetracarboxylic dianhydride (BTDA), para-phenylenediamine (PPD), m-tolidine, and oxydianiline (ODA) are introduced in a controlled composition ratio in a predetermined order and completely dissolved. Then, the resulting product was heated by raising the reactor temperature to 40° C. under a nitrogen atmosphere with continuous stirring for 120 minutes. As a result, a polyamic acid having a primary reaction viscosity of 1,500 cP was prepared.

The polyamic acid prepared in such a manner was stirred to have a final viscosity in a range of 100,000 to 120,000 cP.

After adding carbon black, the catalyst, and the dehydrating agent to the prepared final polyamic acid by adjusting the contents thereof, a polyimide film was formed using an applicator.

### Examples and Comparative Examples

In Examples 1 to 8 and Comparative Examples 1 to 6, each polyimide film was formed according to the preparation example by adjusting the content of the acid dianhydride component, the content of the diamine component, and the type and content of carbon black, as shown in Tables 1 and 2 below.

TABLE 1

| | Composition | | Carbon black (wt %) | | | |
|---|---|---|---|---|---|---|
| | Diamine | Acid dianhydride | Bone | Furnace | Lamp | Thermal |
| | (mol %) | (mol %) | Black | Black | Black | Black |
| Example 1 | PPD: 66/ | BTDA: 33/ | 6.6 | — | — | — |
| Example 2 | m-Tolidine: 34 | BPDA: 32/ | 6.6 | — | — | 2.5 |
| Example 3 | | PMDA: 35 | 6.6 | — | — | 3.0 |
| Example 4 | | | 6.6 | — | 2.0 | — |
| Comparative | | | — | — | — | — |
| Example 1 | | | | | | |
| Comparative | | | — | 2.5 | — | — |
| Example 2 | | | | | | |
| Comparative | | | 6.6 | 2.5 | — | — |
| Example 3 | | | | | | |

TABLE 2

| | Composition | | Carbon black (wt %) | | | |
|---|---|---|---|---|---|---|
| | Diamine | Acid dianhydride | Bone | Furnace | Lamp | Thermal |
| | (mol %) | (mol %) | Black | Black | Black | Black |
| Example 5 | PPD: 15/ | BPDA: 40/ | 6.6 | — | — | — |
| Example 6 | ODA: 15/ | PMDA: 60 | 6.6 | — | — | 2.5 |
| Example 7 | m-Tolidine: 70 | | 6.6 | — | — | 3.0 |
| Example 8 | | | 6.6 | — | 2.0 | — |
| Comparative | | | — | — | — | — |
| Example 4 | | | | | | |
| Comparative | | | — | 2.5 | — | — |
| Example 5 | | | | | | |
| Comparative | | | 6.6 | 2.5 | — | — |
| Example 6 | | | | | | |

The content of carbon black in Tables 1 and 2 is wt % of carbon black contained based on 100 wt % of the polyimide film.

The transmittance, glossiness, dielectric constant (Dk), dielectric loss factor (Df), and chemical resistance index of the formed polyimide film were measured and shown in Tables 3 and 4 below.

TABLE 3

| | | | | | Chemical |
|---|---|---|---|---|---|
| | Transmittance | Glossiness | | | resistance |
| | (%) | (%) | Dk | Df | Index (%) |
| Example 1 | 0.1 | 14 | 3.62 | 0.00412 | 94 |
| Example 2 | 0.03 | 25 | 3.91 | 0.00521 | 91 |
| Example 3 | 0.1 | 28 | 3.95 | 0.00610 | 90 |
| Example 4 | 0.08 | 49 | 3.96 | 0.00819 | 90 |
| Comparative | 90 | 198 | 3.54 | 0.00380 | 95 |
| Example 1 | | | | | |
| Comparative | 40 | 120 | 4.42 | 0.00842 | 91 |
| Example 2 | | | | | |
| Comparative | 0.02 | 17 | 3.51 | 0.01978 | 90 |
| Example 3 | | | | | |

TABLE 4

| | | | | | Chemical |
|---|---|---|---|---|---|
| | Transmittance | Glossiness | | | resistance |
| | (%) | (%) | Dk | Df | index (%) |
| Example 5 | 0.9 | 16 | 3.62 | 0.00454 | 96 |
| Example 6 | 0.15 | 28 | 3.94 | 0.00580 | 92 |
| Example 7 | 0.08 | 34 | 3.97 | 0.00645 | 90 |
| Example 8 | 0.1 | 50 | 3.98 | 0.00849 | 91 |
| Comparative | 75 | 210 | 3.51 | 0.00400 | 97 |
| Example 4 | | | | | |
| Comparative | 41 | 145 | 4.34 | 0.00861 | 92 |
| Example 5 | | | | | |
| Comparative | 0.02 | 24 | 3.42 | 0.02144 | 91 |
| Example 6 | | | | | |

### (1) Measurement of Transmittance

The transmittance of the polyimide films, each independently formed in Examples 1 to 8 and Comparative Examples 1 to 6, was measured in the visible light region by the ASTM D1003 method using a transmittance measuring device (model name: ColorQuesetXE, manufacturer: HunterLab).

### (2) Measurement of Glossiness

The glossiness of the polyimide films, each independently formed in Examples 1 to 8 and Comparative Examples 1 to 6, was measured at an angle of 60° by the ASTM D523 method using a glossiness measuring device (model name: E406L, manufacturer: Elcometer).

### (3) Dielectric Constant

The dielectric constant (Dk) of the polyimide films, each independently formed in Examples 1 to 8 and Comparative Examples 1 to 6, was measured at 10 GHz using an SPDR meter purchased from Keysight.

### (4) Measurement of Dielectric Loss Factor

The dielectric loss factor (Df) of the polyimide films, each independently formed in Examples 1 to 8 and Comparative Examples 1 to 6, was measured by leaving a flexible metal-clad laminate for 72 hours using resist-based Agilent 4294A.

### (5) Measurement of Chemical Resistance Index

The polyimide films, each independently formed in Examples 1 to 8 and Comparative Examples 1 to 6, are subjected to double-sided corona treatment and then bonded to have a structure composed of the polyimide film, a bonding sheet (adhesive), and a copper foil by applying a pressure of 50 kgf for 30 minutes at a temperature of 160° C. using a hot press, thus preparing flexible cupper-clad laminate (FCCL) samples.

The FCCL cut to a size of 4 cm*10 cm is exposed to a 10% NaOH solution for 3 minutes at a temperature of 55° C. and exposed to a desmear solution (10% NaMnO₄+4% NaOH) for 5 minutes at a temperature of 55° C., followed by repeatedly performing a washing process twice. Then, the thickness of the resulting film is measured and compared with the thickness before being exposed to the NaOH and desmear solutions. The level of change in the thickness after being exposed compared to the thickness before being exposed is expressed as a percentage.

As a result of the measurement, the polyimide films of Examples 1 to 8 had a transmittance of 1.0% or lower, a glossiness of 50% or lower, a dielectric loss factor of 0.01 or lower, a dielectric constant of 4.0 or lower, and a chemical resistance index of 90% or higher.

When using bone black and thermal black in combination as in the examples, it was confirmed that with the increasing content of thermal black in carbon black, the glossiness, dielectric constant, and dielectric loss factor values of the polyimide film increased while the chemical resistance index decreased.

Additionally, it was confirmed that when using bone black and lamp black in combination, the glossiness, dielectric constant, and dielectric loss factor values of the polyimide film increased while the chemical resistance index decreased, compared to when using bone black alone.

On the other hand, the polyimide film of Comparative Example 1, in which the contents of the acid dianhydride and diamine components were the same as those in Examples 1 to 4 while not containing carbon black at all, had extremely high transmittance and glossiness.

Additionally, it was confirmed that the polyimide film of Comparative Example 2, containing only furnace black as carbon black, had extremely high transmittance and glossiness compared to the polyimide films of Examples 1 to 4, and the dielectric constant also increased.

Furthermore, it was confirmed that the polyimide film of Comparative Example 3, using bone black and furnace black in combination, had an extremely high dielectric loss factor compared to the polyimide films of Examples 1 to 4.

On the other hand, the polyimide film of Comparative Example 4, in which the contents of the acid dianhydride and diamine components were the same as those in Examples 5 to 8 while not containing carbon black at all, had extremely high transmittance and glossiness.

Additionally, it was confirmed that the polyimide film of Comparative Example 5, containing only furnace black as carbon black, had extremely high transmittance and glossiness compared to the polyimide films of Examples 5 to 8, and the dielectric constant also increased.

Furthermore, it was confirmed that the polyimide film of Comparative Example 6, using bone black and furnace black in combination, had an extremely high dielectric loss factor compared to the polyimide films of Examples 5 to 8.

Therefore, the polyimide films of Examples 1 to 8 formed within the appropriate range herein were excellent in all optical properties (transmittance and glossiness), dielectric properties (dielectric constant and dielectric loss factor), and chemical-resistant properties. However, when formed without falling within the appropriate range herein, it was confirmed that both optical and dielectric properties are challenging to be compatible.

In other words, it was confirmed that the polyimide film formed within the appropriate range herein was a polyimide film having compatible optical and dielectric properties as well as excellent chemical-resistant properties and thus being applicable to various application fields.

The embodiments of the present disclosure regarding the polyimide film and the formation method thereof are only preferred embodiments that allow those skilled in the art to easily practice the present disclosure in the technical field to which the present disclosure belongs and are not limited to the examples described above. Accordingly, the scope of the present disclosure is not limited thereby. Thus, the true technical protection scope of the present disclosure should be defined by the technical spirit of the appended claims. Additionally, those skilled in the art will appreciate that various modifications, alternatives, and substitutions are possible, without departing from the scope and spirit of the present disclosure as disclosed in the accompanying claims. Furthermore, it is apparent that modifications capable of being easily embodied by those skilled in the art are included within the scope of the present disclosure.

### INDUSTRIAL APPLICABILITY

The present disclosure provides a polyimide film in which the types and composition ratios of acid dianhydride component, diamine component, and carbon black are adjusted, thereby providing a polyimide film having excellent optical, dielectric, and chemical-resistant properties.

Such a polyimide film may be applied to various fields in need of a polyimide film having excellent optical, dielectric, and chemical-resistant properties and is, for example, applicable to a coverlay.

1. A polyimide film having a transmittance of 1.0% or lower, a glossiness of 50% or lower, and a dielectric loss factor of 0.01 or lower.

2. The polyimide film of claim 1, wherein the polyimide film has a dielectric constant of 4.0 or lower and a chemical resistance index of 90% or higher.

3. The polyimide film of claim 1, wherein the polyimide film is obtainable by reacting a polyamic acid solution through an imidization reaction, the polyamic acid solution comprising:
an acid dianhydride component comprising two or more selected from the group consisting of biphenyl-tetracarboxylic dianhydride (BPDA), pyromellitic dianhydride (PMDA), oxydiphthalic anhydride (ODPA), and benzophenone tetracarboxylic dianhydride (BTDA); and
a diamine component comprising two or more selected from the group consisting of para-phenylenediamine (PPD), m-tolidine, oxydianiline (ODA), and 1,3-bis(aminophenoxy)benzene (TPE-R).

4. The polyimide film of claim 3, wherein the polyimide film is obtainable by reacting the polyamic acid solution through the imidization reaction, the polyamic acid solution comprising:
the acid dianhydride component comprising two or more selected from the group consisting of biphenyl-tetracarboxylic dianhydride, pyromellitic dianhydride, and benzophenone tetracarboxylic dianhydride; and
the diamine component comprising two or more selected from the group consisting of para-phenylenediamine, m-tolidine, and oxydianiline.

5. The polyimide film of claim 4, wherein the biphenyl-tetracarboxylic dianhydride has a content of 20 mol % or more and 50 mol % or less,
the pyromellitic dianhydride has a content of 25 mol % or more and 70 mol % or less, and
the benzophenone tetracarboxylic dianhydride has a content of 50 mol % or less, based on 100 mol % of the total content of the acid dianhydride component.

6. The polyimide film of claim 4, wherein the para-phenylenediamine has a content of 5 mol % or more and 75 mol % or less,
the m-tolidine has a content of 25 mol % or more and 80 mol % or less, and
the oxydianiline has a content of 25 mol % or less, based on 100 mol % of the total content of the diamine component.

7. The polyimide film of claim 1, wherein the polyimide film comprises carbon black.

8. The polyimide film of claim 7, wherein the carbon black comprises one or more selected from the group consisting of bone black, lamp black, and thermal black.

9. The polyimide film of claim 7, wherein the carbon black is contained in an amount of 1 wt % or more and 15 wt % or less based on 100 wt % of the polyimide film.

10. The polyimide film of claim 1, wherein the polyimide film has a thickness of 7.5 μm or larger and 75 μm or smaller.

11. A method of forming a polyimide film, the method comprising:
(a) preparing a polyamic acid by polymerizing an acid dianhydride component comprising two or more selected from the group consisting of biphenyl-tetracarboxylic dianhydride (BPDA), pyromellitic dianhydride (PMDA), oxydiphthalic anhydride (ODPA), and benzophenone tetracarboxylic dianhydride (BTDA) and a diamine component comprising two or more selected from the group consisting of para-phenylenediamine (PPD), m-tolidine, oxydianiline (ODA), and 1,3-bis(aminophenoxy)benzene (TPE-R) in an organic solvent;
(b) mixing and dispersing carbon black in the polyamic acid; and
(c) imidizing the polyamic acid, wherein the carbon black comprises one or more selected from the group consisting of bone black, lamp black, and thermal black.

12. A coverlay comprising the polyimide film of any one of claims 1 to 10.
